(19) United States
(12) Patent Application Publication
(10) Pub. No.: US 2026/0319886 A1
(43) Pub. Date: Oct. 15, 2026

(54) DICE FAILURE CORRECTION USING PARITY DICE

(71) Applicant: Micron Technology, Inc., Boise, ID (US)

(72) Inventors: Marco SFORZIN, Cernusco Sul Naviglio (IT); Daniele BALLUCHI, Cernusco Sul Naviglio (IT); Emanuele CONFALONIERI, Segrate (IT); Danilo CARACCIO, Milano (IT); Nicola DEL GATTO, Cassina De' Pecchi (IT); Massimiliano PATRIARCA, Milano (IT)

(21) Appl. No.: 19/467,103

(22) Filed: Feb. 2, 2026

Related U.S. Application Data
(60) Provisional application No. 63/777,745, filed on Mar. 26, 2025.

(51) Int. Cl. G06F 11/10

(52) U.S. Cl. CPC G06F 11/1048; G06F 11/1076

(57) ABSTRACT

Implementations described herein relate to dice failure correction using parity dice. In some implementations, a memory device may identify a plurality of dice that includes a set of data block dice and a set of parity dice. The memory device may detect one or more dice failures associated with the set of data block dice. The memory device may correct the one or more dice failures using the set of parity dice. The memory device may store corrected data associated with one or more corrected data block dice in one or more parity dice in the set of parity dice based on a reconfiguration of the set of parity dice. The memory device may apply remaining parity dice in the set of parity dice to correct one or more additional dice failures associated with the set of data block dice.

### CROSS-REFERENCE TO RELATED APPLICATION

This Patent Application claims priority to U.S. Provisional Patent Application No. 63/777,745, filed on Mar. 26, 2025 entitled “DICE FAILURE CORRECTION USING PARITY DICE,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to dice failure correction using parity dice.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of dice failure correction using parity dice.

FIG. 2 is a diagrammatic view of an example memory device.

FIG. 3 is a diagram illustrating an example of parity dice in a stripe.

FIG. 4 is a diagram illustrating an example associated with dice failure correction using parity dice.

FIG. 5 is a diagram illustrating an example associated with dice failure correction using parity dice.

FIG. 6 is a diagram illustrating an example associated with dice failure correction using parity dice.

FIG. 7 is a diagram illustrating an example associated with dice failure correction using parity dice.

FIG. 8 is a diagram illustrating an example associated with dice failure correction using parity dice.

FIG. 9 is a flowchart of an example method associated with dice failure correction using parity dice.

### DETAILED DESCRIPTION

A memory device may have an array of memory components. Rows of the array may be referred to as ranks, and columns of the array may be referred to as channels. A channel may be associated with an N dice (or dies) stripe, where N is a positive integer. In one example, a channel may be associated with a 10 dice stripe. The N dice stripe may be replicated a plurality of times for a plurality of channels. The plurality of channels may share the same bus in different ranks. A stripe may be associated with a plurality of dice. “Striping” may refer to spreading data across multiple memory modules, ranks, or chips to improve bandwidth and parallelism. In striping, data may be split into chunks and written across multiple channels, memory banks, memory modules, ranks, or chips. “Dice” (plural of die) in memory may refer to individual silicon chips inside a memory module, where data may be stored on the individual silicon chips. “Dice” and “dies” may be used interchangeably herein.

A data block, which may be used by a host, may be stored in a stripe of N dice for correction purposes. A number of dies, chips, or memory components may form the stripe of N dice. The stripe of N dice may be subjected to chip failures. For example, certain chips (or dice) within the stripe of N dice may fail. Available parity dice may be exploited to maximize a correction capability toward chip failures. Parity dice may contain parity bits. Parity dice may be used to employ a correction scheme based on Reed-Solomon codes. An entire data stream may be partitioned (or striped) into a certain number of codewords. A certain number of dice may be corrected within a stripe. As an example, for each die to be corrected, 2 parity dice may be needed, which may be based on Reed-Solomon code theory. However, in some cases, the limitation of 2 parity dice for each die correction may be insufficient when numerous dice failures are present. For example, a stripe may include 4 parity dice but the stripe may have 3 failed dice. In this example, the 4 parity dice may be insufficient to correct the 3 failed dice. As a result, a number of available parity dice may be insufficient to correct all chip failures associated with the stripe, such that a presence of chip failures may degrade an overall system performance.

In some implementations, a memory device, such as a double data rate (DDR) memory device, may identify a plurality of dice that includes a set of data block dice and a set of parity dice. The plurality of dice may correspond to a stripe of N dice. The plurality of dice may correspond to a plurality of memory chips or a plurality of memory components. The memory device may detect one or more dice failures associated with the set of data block dice. The memory device may correct the one or more dice failures using the set of parity dice. The memory device may store corrected data associated with one or more corrected data block dice in one or more parity dice in the set of parity dice based on a reconfiguration of the set of parity dice. The memory device may apply remaining parity dice in the set of parity dice to correct one or more additional dice failures associated with the set of data block dice. The set of parity dice may be used for a baseline dice failure correction, and the remaining parity dice may be used for a residual dice failure correction. The remaining parity dice may not store the corrected data associated with the one or more corrected data block dice. The remaining parity dice may be used for single device data correction or double device data correction. The set of data block dice may be associated with a first quantity, the set of parity dice may be associated with a second quantity, and a quantity of dice failures that are able to be corrected using parity dice may be based on the first quantity and/or the second quantity.

In some implementations, dice failures may be corrected by using available parity dice. When a correction capability of the baseline correcting code is reached, the stripe may be reconfigured to store, in parity dice, data of failed dice. The data of failed dice may be corrected data (e.g., data that is corrected using parity dice). The remaining parity dice may be used to implement the residual dice correction system. In some implementations, certain parity dice may be used to correct a failed die, and then corrected data from the failed die may be stored on those parity dice. Remaining parity dice may be used to provide further correction capability. In this example, some parity dice may be used multiple times for providing the correction capability, which may increase a number of dice failures that are able to be corrected when a certain number of parity dice are allocated for a given stripe. In other words, by extending a dice correction capability by employing data replacement, a number of failed dice that are able to be corrected using the certain number of parity dice may be increased, which may improve an overall system performance.

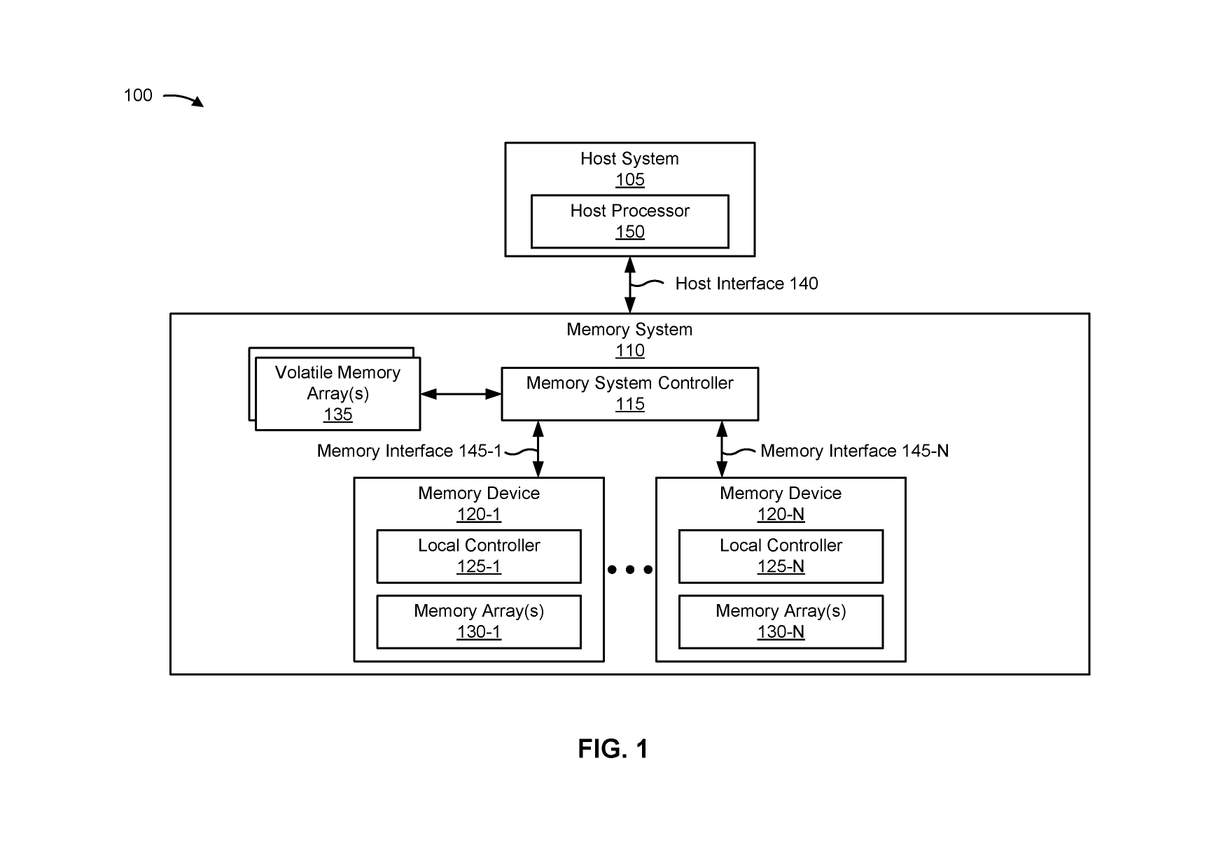

FIG. 1 is a diagram illustrating an example system 100 capable of dice failure correction using parity dice. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-b through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a DDR interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to identify a plurality of dice that includes a set of data block dice and a set of parity dice; detect one or more dice failures associated with the set of data block dice; correct the one or more dice failures using the set of parity dice; store corrected data associated with one or more corrected data block dice in one or more parity dice in the set of parity dice based on a reconfiguration of the set of parity dice; and apply remaining parity dice in the set of parity dice to correct one or more additional dice failures associated with the set of data block dice.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

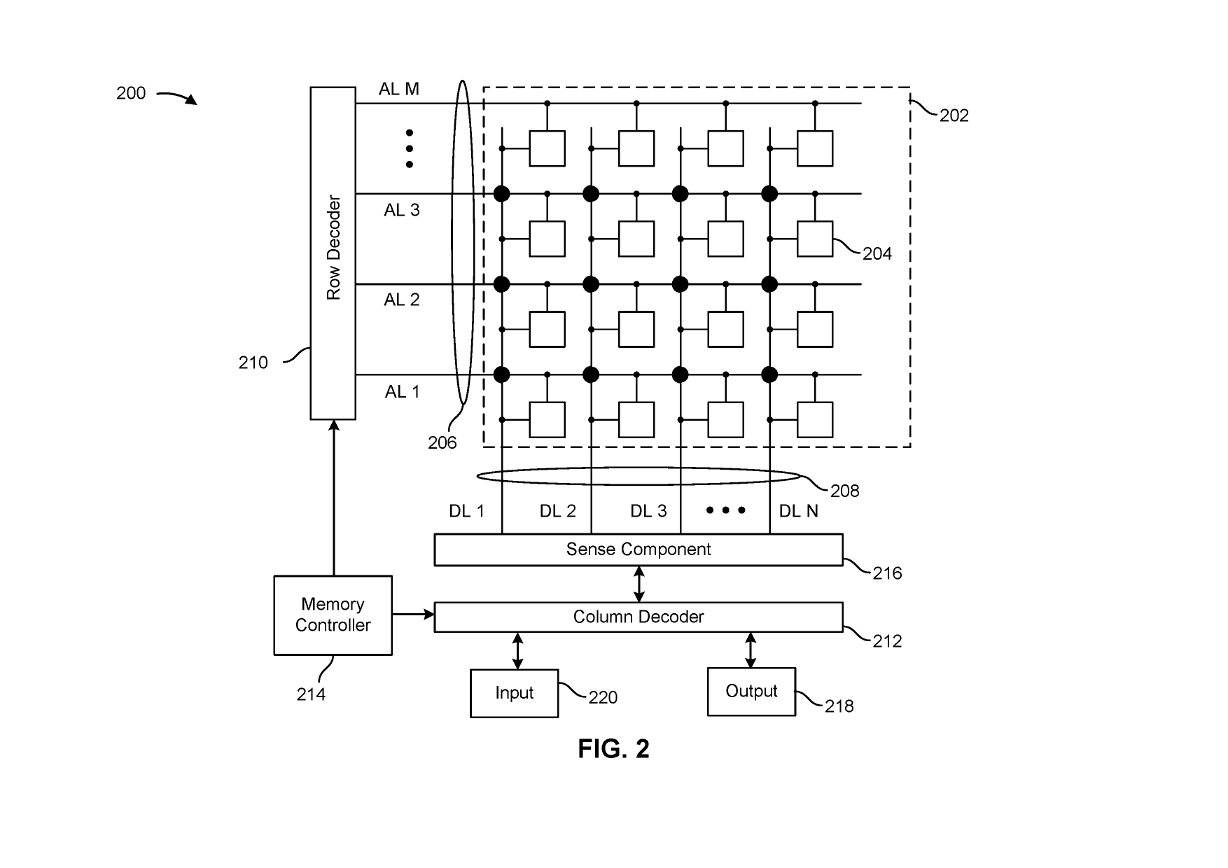

FIG. 2 is a diagrammatic view of an example memory device 200. The memory device 200 may include a memory array 202 that includes multiple memory cells 204. A memory cell 204 is programmable or configurable into a data state of multiple data states (e.g., two or more data states). For example, a memory cell 204 may be set to a particular data state at a particular time, and the memory cell 204 may be set to another data state at another time. A data state may correspond to a value stored by the memory cell 204. The value may be a binary value, such as a binary 0 or a binary 1, or may be a fractional value, such as 0.5, 1.5, or the like. A memory cell 204 may include a capacitor to store a charge representative of the data state. For example, a charged and an uncharged capacitor may represent a first data state and a second data state, respectively. As another example, a first level of charge (e.g., fully charged) may represent a first data state, a second level of charge (e.g., fully discharged) may represent a second data state, a third level of charge (e.g., partially charged) may represent a third data state, and so on.

Operations such as reading and writing (i.e., cycling) may be performed on memory cells 204 by activating or selecting the appropriate access line 206 (shown as access lines AL 1 through AL M) and digit line 208 (shown as digit lines DL 1 through DL N). An access line 206 may also be referred to as a “row line” or a “word line,” and a digit line 208 may also be referred to a “column line” or a “bit line.” Activating or selecting an access line 206 or a digit line 208 may include applying a voltage to the respective line. An access line 206 and/or a digit line 208 may comprise, consist of, or consist essentially of a conductive material, such as a metal (e.g., copper, aluminum, gold, titanium, or tungsten) and/or a metal alloy, among other examples. In FIG. 2, each row of memory cells 204 is connected to a single access line 206, and each column of memory cells 204 is connected to a single digit line 208. By activating one access line 206 and one digit line 208 (e.g., applying a voltage to the access line 206 and digit line 208), a single memory cell 204 may be accessed at (e.g., is accessible via) the intersection of the access line 206 and the digit line 208. The intersection of the access line 206 and the digit line 208 may be called an “address” of a memory cell 204.

In some implementations, the logic storing device of a memory cell 204, such as a capacitor, may be electrically isolated from a corresponding digit line 208 by a selection component, such as a transistor. The access line 206 may be connected to and may control the selection component. For example, the selection component may be a transistor, and the access line 206 may be connected to the gate of the transistor. Activating the access line 206 results in an electrical connection or closed circuit between the capacitor of a memory cell 204 and a corresponding digit line 208. The digit line 208 may then be accessed (e.g., is accessible) to either read from or write to the memory cell 204.

A row decoder 210 and a column decoder 212 may control access to memory cells 204. For example, the row decoder 210 may receive a row address from a memory controller 214 and may activate the appropriate access line 206 based on the received row address. Similarly, the column decoder 212 may receive a column address from the memory controller 214 and may activate the appropriate digit line 208 based on the column address.

Upon accessing a memory cell 204, the memory cell 204 may be read (e.g., sensed) by a sense component 216 to determine the stored data state of the memory cell 204. For example, after accessing the memory cell 204, the capacitor of the memory cell 204 may discharge onto its corresponding digit line 208. Discharging the capacitor may be based on biasing, or applying a voltage, to the capacitor. The discharging may induce a change in the voltage of the digit line 208, which the sense component 216 may compare to a reference voltage (not shown) to determine the stored data state of the memory cell 204. For example, if the digit line 208 has a higher voltage than the reference voltage, then the sense component 216 may determine that the stored data state of the memory cell 204 corresponds to a first value, such as a binary 1. Conversely, if the digit line 208 has a lower voltage than the reference voltage, then the sense component 216 may determine that the stored data state of the memory cell 204 corresponds to a second value, such as a binary 0. The detected data state of the memory cell 204 may then be output (e.g., via the column decoder 212) to an output component 218 (e.g., a data buffer). A memory cell 204 may be written (e.g., set) by activating the appropriate access line 206 and digit line 208. The column decoder 212 may receive data, such as input from input component 220, to be written to one or more memory cells 204. A memory cell 204 may be written by applying a voltage across the capacitor of the memory cell 204.

The memory controller 214 may control the operation (e.g., read, write, re-write, refresh, and/or recovery) of the memory cells 204 via the row decoder 210, the column decoder 212, and/or the sense component 216. The memory controller 214 may generate row address signals and column address signals to activate the desired access line 206 and digit line 208. The memory controller 214 may also generate and control various voltages used during the operation of the memory array 202.

As indicated above, FIG. 2 is provided as an example. Other examples may differ from what is described with respect to FIG. 2.

DDR memory is a type of RAM used in electronic devices. DDR memory may be referred to as “double data rate” because data may be transferred on both the rising and falling edges of the clock signal, which may effectively double the data transfer rate as compared to single data rate (SDR) memory. DDR5 memory may be used in high performance computing, gaming servers, and artificial intelligence (AI) applications. DDR5 memory may be associated with higher speeds as compared to earlier generations of DDR memory. For example, DDR5 memory may start at 4800 megatransfers per second (MT/s) and may exceed 8400 MT/s in some cases. DDR5 memory may be associated with increased bandwidth as compared to earlier generations of DDR memory. For example, DDR5 memory may support up to 38.4 gigabytes per second (GB/s) per module (at 4800 MT/s), which may improve multitasking and data-heaving applications. DDR5 memory may be associated with lower power consumption as compared to earlier generations of DDR memory. DDR5 memory may support greater capacity as compared to earlier generations of DDR memory. For example, DDR5 memory may support up to 128 gigabytes (GB) per module. DDR5 memory may support on-die error correction code (ECC), which may improve reliability by detecting and correcting memory errors internally. DDR5 memory may be associated with a power management integrated circuit (PMIC), which may move power regulation from the motherboard to the module for better efficiency and stability.

A memory system, such as a DDR5 memory system, may be organized in channels and ranks. A channel may define a communication between memory and a processor, where more channels allow for higher data transfer rates. In other words, more channels may correspond to higher bandwidth. A rank may be a data block that a memory module is able to access independently, where memory modules may have multiple ranks for better efficiency. For a single rank, data may be stored on one set of memory chips. For dual rank, data may be able to be stored on two sets of memory chips. The memory system may have multiple ranks per channel. For example, a dual-channel system may have two dual-rank memory modules.

In one example, a memory device may have an array of memory components. Rows of the array may be referred to as ranks, and columns of the array may be referred to as channels. A channel may be associated with an N dice (or dies) stripe. In one example, a channel may be associated with a 10 dice stripe. The N dice stripe may be replicated a plurality of times for a plurality of channels. The plurality of channels may share the same bus in different ranks. A stripe may be associated with a plurality of dice. In other words, “stripe” may refer to a group of dice. “Striping” may refer to spreading data across multiple memory modules, ranks, or chips to improve bandwidth and parallelism. In striping, data may be split into chunks and written across multiple channels, memory banks, memory modules, ranks, or chips. “Dice” (plural of die) in memory may refer to individual silicon chips inside a memory module, where data may be stored on the individual silicon chips. These memory dice store actual data. A single memory module may have multiple memory dies. More dies per module may increase capacity. Each die may include memory cells, word lines, bit lines, and/or a memory controller interface.

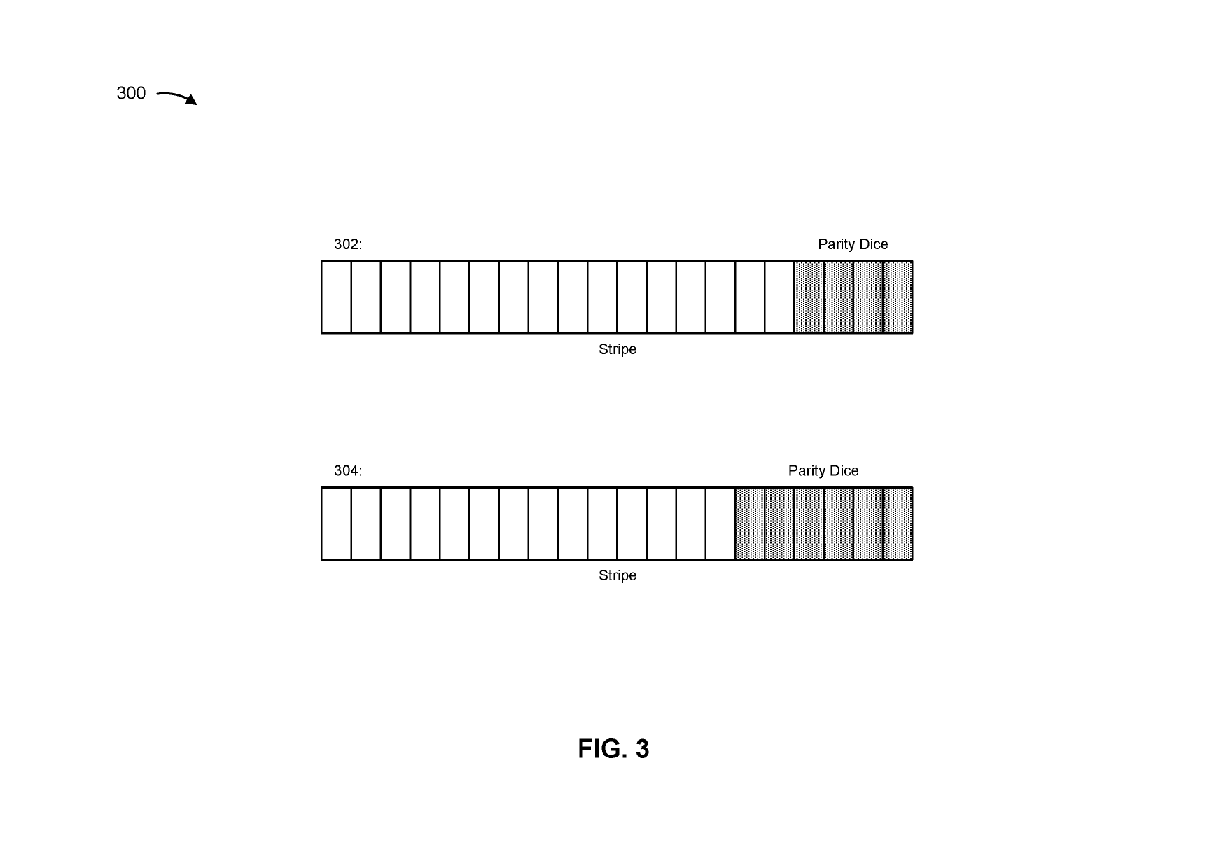

FIG. 3 is a diagram of an example 300 of parity dice in a stripe. The operations described in connection with FIG. 3 may be performed by the memory system 110 and/or one or more components of the memory system 110, such as the memory system controller 115, one or more memory devices 120, and/or one or more local controllers 125.

A data block, which may be used by a host, may be stored in a stripe of N dice for correction purposes. In one example, N may be 10. A number of dies, chips, or memory components may form the stripe of N dice. The stripe of N dice may be subjected to chip failures. For example, certain chips (or dice) within the stripe of N dice may fail. Available parity dice may be exploited to maximize a correction capability toward chip failures.

As shown by reference number 302, a stripe may include 20 dice (e.g., 20 chips or 20 memory components). The 20 dice may be split into 16 dice for a data block and 4 dice for parity information. The 4 dice for parity information may be referred to as 4 parity dice, where the 4 parity dice may store parity bits for correcting chip failures associated with the 16 dice. One die (e.g., one chip or one memory component) may hold 8 bytes of the data block. Two parity dice may be needed to correct one chip failure. In this example, the 4 parity dice may be capable of correcting two chip failures. In other words, when 2 dice of the 16 dice are associated with failure, the 2 dice may be corrected by using the 4 parity dice.

As shown by reference number 304, a stripe may include 20 dice (e.g., 20 chips or 20 memory components). The 20 dice may be split into 14 dice for a data block and 6 dice for parity information. The 6 dice for parity information may be referred to as 6 parity dice, where the 6 parity dice may store parity bits for correcting chip failures associated with the 14 dice. In this example, the 6 parity dice may be capable of correcting 3 chip failures. In other words, when 3 dice of the 14 dice are associated with failure, the 3 dice may be corrected by using the 6 parity dice.

A correction scheme may be based on Reed-Solomon codes. An entire data stream may be partitioned (or striped) into a certain number of codewords. A certain number of dice may be corrected within a stripe. As an example, for each die to be corrected, 2 parity dice may be needed, which may be based on Reed-Solomon code theory. However, in some cases, the limitation of 2 parity dice for each die correction may be insufficient when numerous dice failures are present. For example, a stripe may include 4 parity dice but the stripe may have 3 failed dice. In this example, the 4 parity dice may be insufficient to correct the 3 failed dice. As a result, a number of available parity dice may be insufficient to correct all chip failures associated with the stripe, such that a presence of chip failures may degrade an overall system performance.

As indicated above, FIG. 3 is provided as an example. Other examples may differ from what is described with regard to FIG. 3.

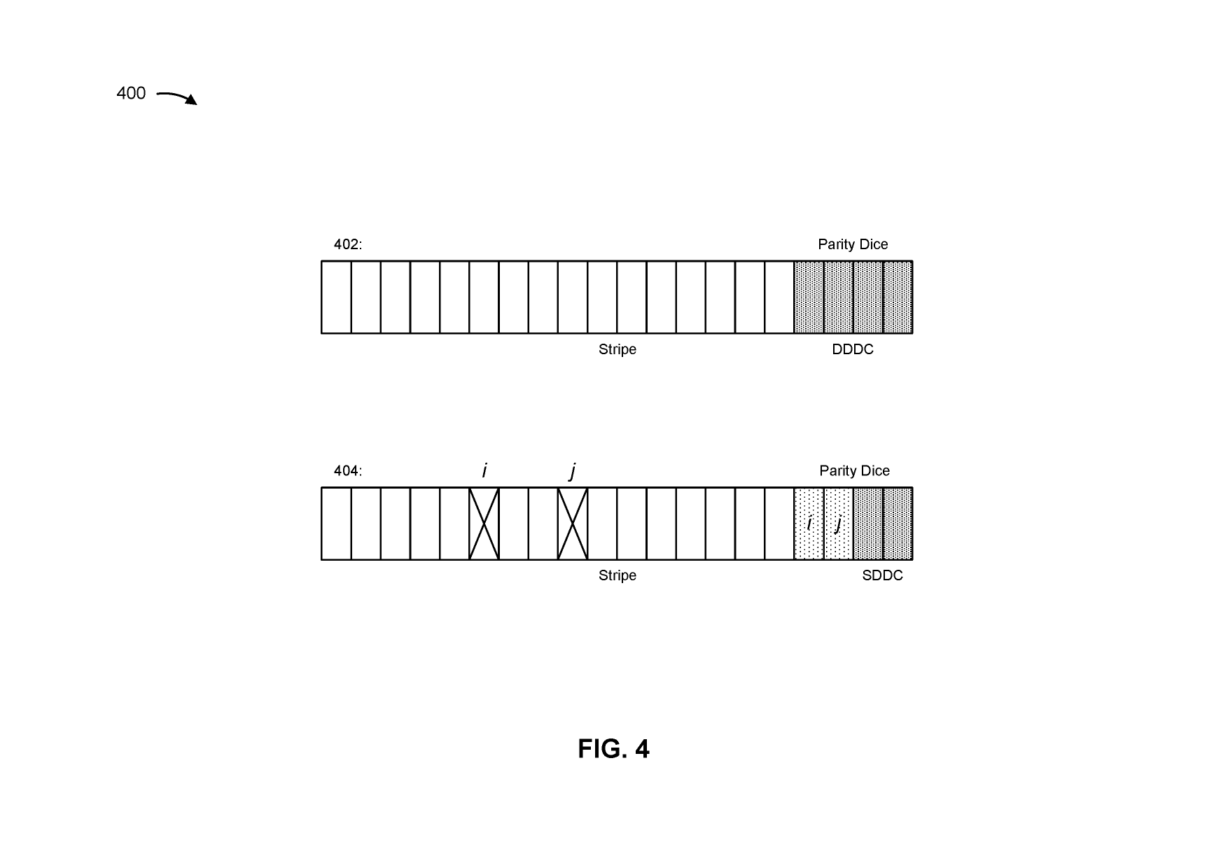

FIG. 4 is a diagram of an example 400 associated with dice failure correction using parity dice. The operations described in connection with FIG. 4 may be performed by the memory system 110 and/or one or more components of the memory system 110, such as the memory system controller 115, one or more memory devices 120, and/or one or more local controllers 125.

In some implementations, chip failures may be corrected by using available parity dice. When a correction capability of a baseline correcting code is reached, a stripe may be reconfigured to store, in parity dice, data of failed dice. The data of failed dice may be corrected data (e.g., data that is corrected using parity dice). Remaining parity dice may be used to implement a residual dice correction system. In some implementations, certain parity dice may be used to correct a failed die, and then corrected data from that failed die may be stored on those parity dice. Remaining parity dice may be used to provide further correction capability. In this example, some parity dice may be used multiple times for providing the correction capability, which may increase a number of chip failures that are able to be corrected when a certain number of parity dice are allocated for a given stripe, which may improve an overall system performance.

As shown by reference number 402, a stripe may include 16 dice for storing a data block and 4 parity dice for error correction. With the 4 parity dice, up to 2 chip failures may be corrected, which may be in accordance with a double device data correction (DDDC). The up to 2 chip failures may be corrected with the 4 parity dice by using Reed-Solomon codes.

As shown by reference number 404, a stripe may include 16 dice for storing a data block and 4 parity dice for error correction. In this example, 2 chip failures may occur (e.g., at chip/die i and chip/die j). When the 2 chip failures occur, 2 out of the 4 parity dice may be used to effectively replace the 2 failed dice, and the remaining 2 dice of the 4 parity dice may be used to build a single device data correction (SDDC) mechanism. More specifically, when the 2 chip failures occur, the double device data correction may be employed to correct the 2 chip failures. All 4 parity dice may be used to correct the 2 chip failures associated with chip/die i and chip/die j. Corrected data may be used to reconfigure an ECC stripe. For example, 2 of the 4 parity dice may be used to store corrected data previously contained in chip/die i and chip/die j. In other words, chip/die i and chip/die j may be corrected using the 4 parity dice, where such corrected data may be stored in 2 of the 4 parity dice. The remaining 2 parity dice may be used to implement a single device data correction that covers the entire stripe. Data corresponding to the failed chip/die i and chip/die j may be zero-padded in an encoder and a decoder of the single device data correction. As a result, a double device data correction may be extended to a triple device data correction. By reconfiguring the ECC stripe and storing the corrected data on certain parity dice, up to 3 chip failures may be corrected instead of 2 chip failures, even though only 4 parity dice may be available.

As indicated above, FIG. 4 is provided as an example. Other examples may differ from what is described with regard to FIG. 4.

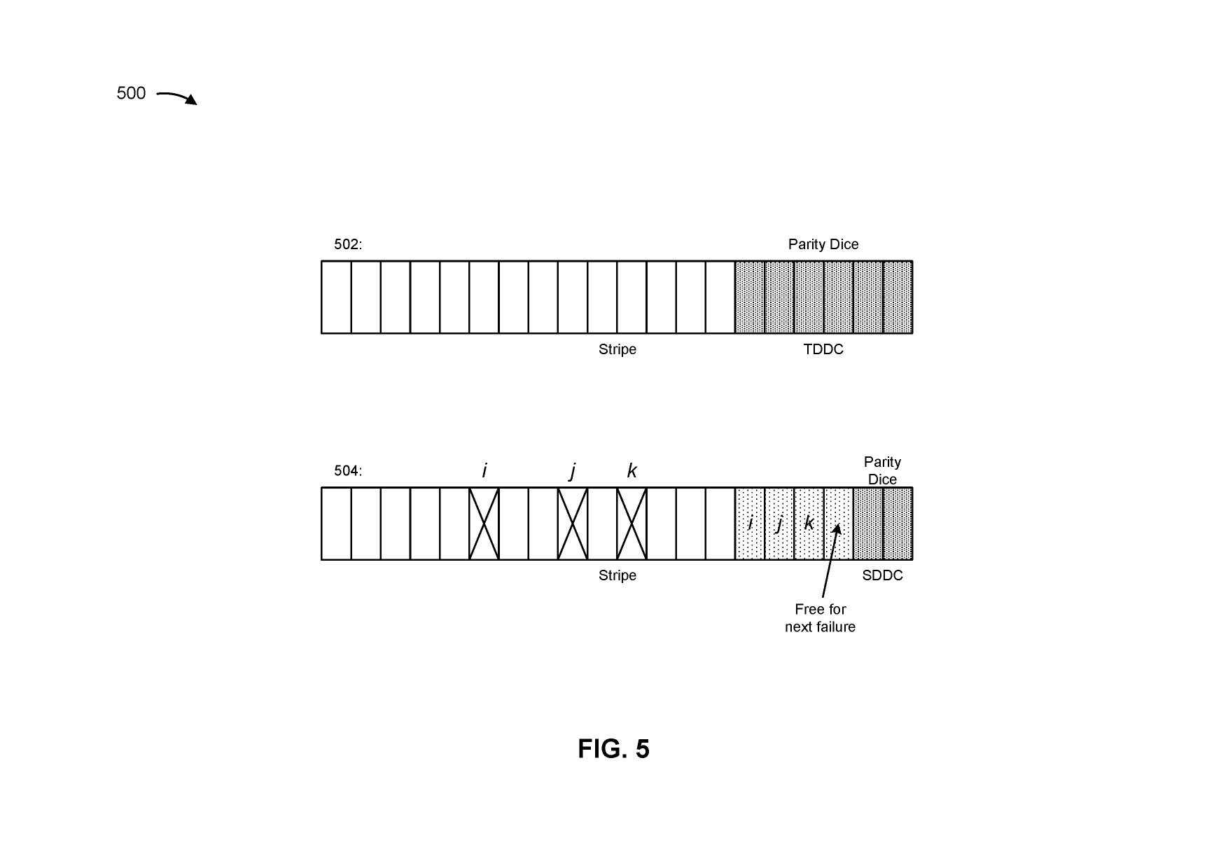

FIG. 5 is a diagram of an example 500 associated with dice failure correction using parity dice. The operations described in connection with FIG. 5 may be performed by the memory system 110 and/or one or more components of the memory system 110, such as the memory system controller 115, one or more memory devices 120, and/or one or more local controllers 125.

As shown by reference number 502, a stripe may include 14 dice for storing a data block and 6 parity dice for error correction. With the 6 parity dice, up to 3 chip failures may be corrected, which may be in accordance with a triple device data correction (TDDC). The up to 3 chip failures may be corrected with the 6 parity dice by using Reed-Solomon codes.

As shown by reference number 504, a stripe may include 14 dice for storing a data block and 6 parity dice for error correction. In this example, 3 chip failures may occur (e.g., at chip/die i, chip/die j, and chip/die k). When the 3 chip failures occur, 3 out of the 6 parity dice may be used to effectively replace the 3 failed dice, 1 parity die may be used as a spare resource for a next chip failure, and the remaining 2 dice of the 6 parity dice may be used to build a single device data correction mechanism. More specifically, when the 3 chip failures occur, the triple device data correction may be employed to correct the 3 chip failures. All 6 parity dice may be used to correct the 3 chip failures associated with chip/die i, chip/die j, and chip/die k. Corrected data may be used to reconfigure an ECC stripe. For example, 3 of the 6 parity dice may be used to store corrected data previously contained in chip/die i, chip/die j, and chip/die k. In other words, chip/die i, chip/die j, and chip/die k may be corrected using the 6 parity dice, where such corrected data may be stored in 3 of the 6 parity dice. One parity die may be reserved as a spare for a future chip failure. The remaining 2 parity dice may be used to implement a single device data correction that covers the entire stripe. Data corresponding to the failed chip/die i, chip/die j, and chip/die k may be zero-padded in an encoder and a decoder of the single device data correction. As a result, a triple device data correction may be extended to a five device data correction. By reconfiguring the ECC stripe and storing the corrected data on certain parity dice, up to 5 chip failures may be corrected instead of 3 chip failures, even though only 6 parity dice may be available.

As indicated above, FIG. 5 is provided as an example. Other examples may differ from what is described with regard to FIG. 5.

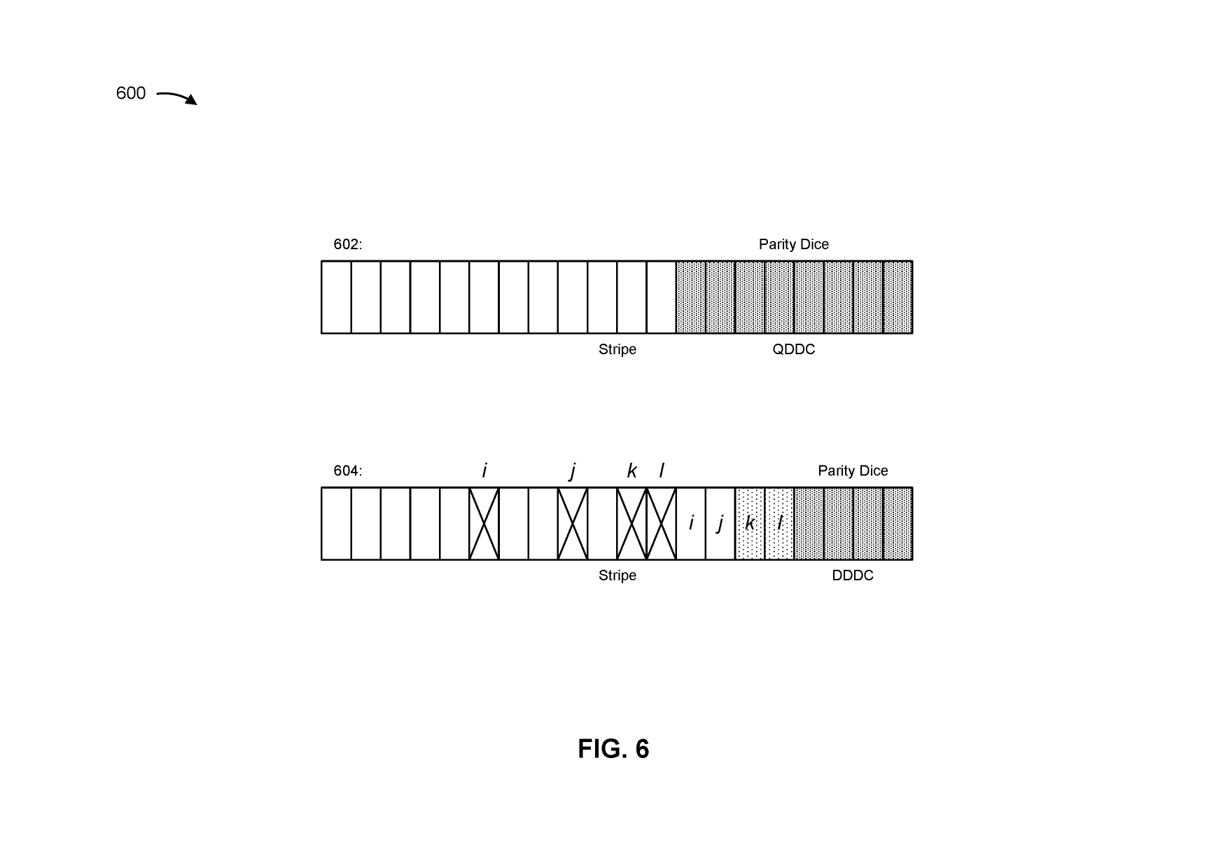

FIG. 6 is a diagram of an example 600 associated with dice failure correction using parity dice. The operations described in connection with FIG. 6 may be performed by the memory system 110 and/or one or more components of the memory system 110, such as the memory system controller 115, one or more memory devices 120, and/or one or more local controllers 125.

As shown by reference number 602, a stripe may include 12 dice for storing a data block and 8 parity dice for error correction. With the 8 parity dice, up to 4 chip failures may be corrected, which may be in accordance with a quad device data correction (QDDC). The up to 4 chip failures may be corrected with the 8 parity dice by using Reed-Solomon codes.

As shown by reference number 604, a stripe may include 12 dice for storing a data block and 8 parity dice for error correction. In this example, 4 chip failures may occur (e.g., at chip/die i, chip/die j, chip/die k, and chip/die l). When the 4 chip failures occur, 4 out of the 8 parity dice may be used to effectively replace the 4 failed dice, and the remaining 4 dice of the 8 parity dice may be used to build a double device data correction mechanism. More specifically, when the 4 chip failures occur, the quad device data correction may be employed to correct the 4 chip failures. All 8 parity dice may be used to correct the 4 chip failures associated with chip/die i, chip/die j, chip/die k, and chip/die l. Corrected data may be used to reconfigure an ECC stripe. For example, 4 of the 8 parity dice may be used to store corrected data previously contained in chip/die i, chip/die j, chip/die k, and chip/die l. In other words, chip/die i, chip/die j, chip/die k, and chip/die l may be corrected using the 8 parity dice, where such corrected data may be stored in 4 of the 8 parity dice. The remaining 4 parity dice may be used to implement a double device data correction that covers the entire stripe. Data corresponding to the failed chip/die i, chip/die j, chip/die k, and chip/die l may be zero-padded in an encoder and a decoder of the double device data correction. The remaining 4 parity dice, which may be associated with the double device data correction, may be utilized to correct an additional 3 chip failures. As a result, a quad device data correction may be extended to a seven device data correction. By reconfiguring the ECC stripe and storing the corrected data on certain parity dice, up to 7 chip failures may be corrected instead of 4 chip failures, even though only 8 parity dice may be available.

As indicated above, FIG. 6 is provided as an example. Other examples may differ from what is described with regard to FIG. 6.

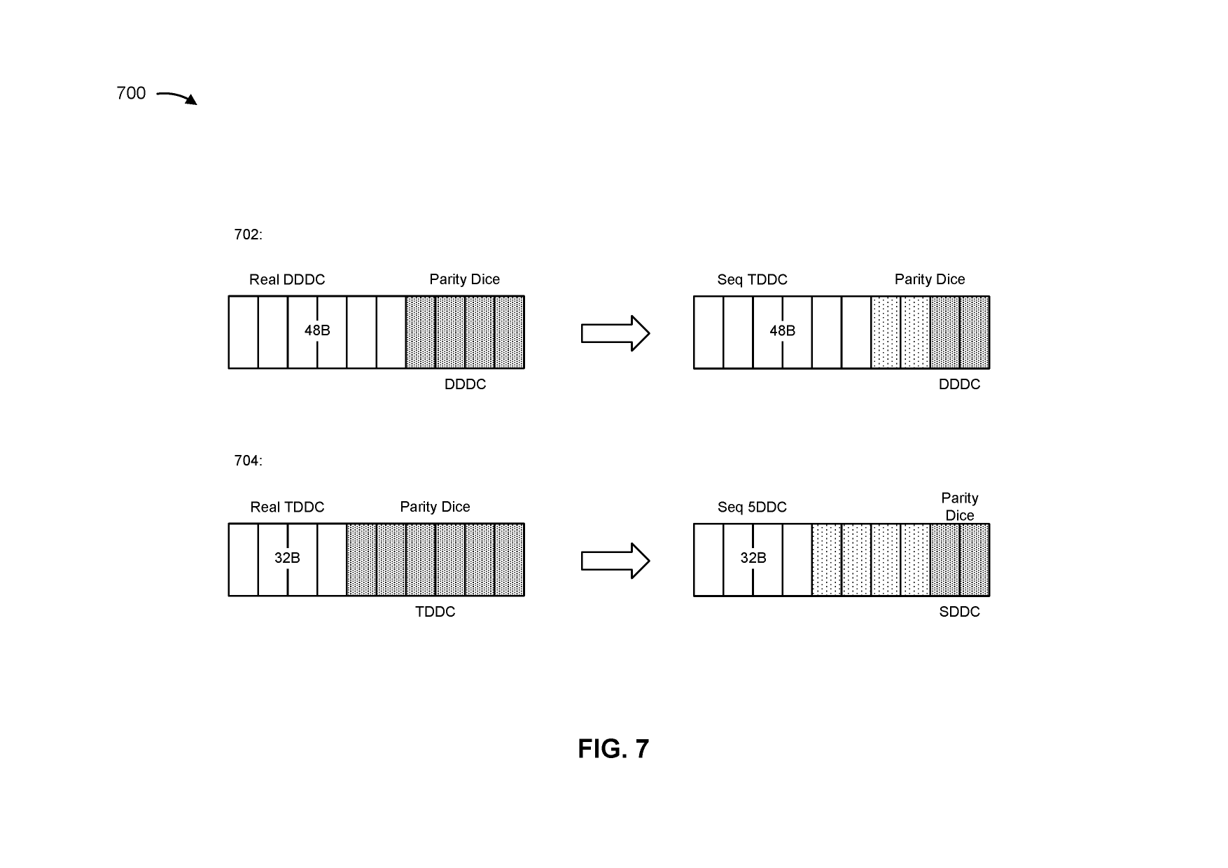

FIG. 7 is a diagram of an example 700 associated with dice failure correction using parity dice. The operations described in connection with FIG. 7 may be performed by the memory system 110 and/or one or more components of the memory system 110, such as the memory system controller 115, one or more memory devices 120, and/or one or more local controllers 125.

As shown by reference number 702, a 10-die stripe may include 6 dice for storing a data block and 4 parity dice for error correction. The 6 dice may be associated with 48 bytes of data (e.g., each die may be 8 bytes). The 4 parity dice may be associated with a real double device data correction. By reconfiguring an ECC stripe and storing corrected data on certain parity dice, a sequential triple device data correction may be achieved. The 4 parity dice may be utilized to correct 2 chip failures. Corrected data may be stored on 2 of the 4 parity dice, and the remaining 2 parity dice may be used to implement a single device data correction. The single device data correction may be able to correct 1 additional chip failure, such that a total of 3 chip failures may be corrected when 4 parity dice are available.

As shown by reference number 704, a 10-die stripe may include 4 dice for storing a data block and 6 parity dice for error correction. The 4 dice may be associated with 32 bytes of data (e.g., each die may be 8 bytes). The 6 parity dice may be associated with a real triple device data correction. By reconfiguring an ECC stripe and storing corrected data on certain parity dice, a sequential five device data correction may be achieved. The 6 parity dice may be utilized to correct 3 chip failures. Corrected data may be stored on 3 of the 6 parity dice, 1 parity die may be used as a spare resource for a next chip failure, and the remaining 2 parity dice may be used to implement a single device data correction. The single device data correction may be able to correct 1 additional chip failure, such that a total of 5 chip failures may be corrected when 6 parity dice are available.

As indicated above, FIG. 7 is provided as an example. Other examples may differ from what is described with regard to FIG. 7.

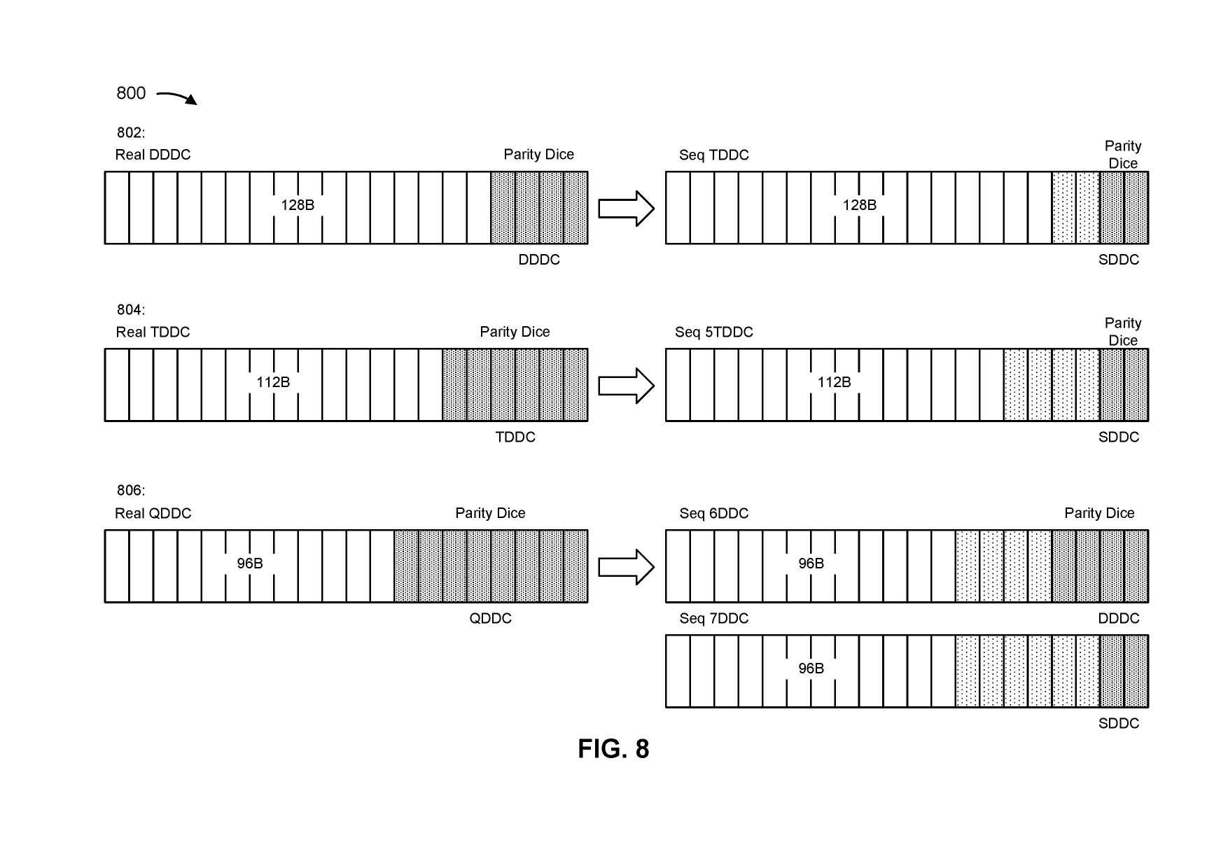

FIG. 8 is a diagram of an example 800 associated with dice failure correction using parity dice. The operations described in connection with FIG. 8 may be performed by the memory system 110 and/or one or more components of the memory system 110, such as the memory system controller 115, one or more memory devices 120, and/or one or more local controllers 125.

As shown by reference number 802, a 20-die stripe may include 16 dice for storing a data block and 4 parity dice for error correction. The 4 dice may be associated with 128 bytes of data (e.g., each die may be 8 bytes). The 4 parity dice may be associated with a real double device data correction. By reconfiguring an ECC stripe and storing corrected data on certain parity dice, a sequential triple device data correction may be achieved. The 4 parity dice may be utilized to correct 2 chip failures. Corrected data may be stored on 2 of the 4 parity dice, and the remaining 2 parity dice may be used to implement a single device data correction. The single device data correction may be able to correct 1 additional chip failure, such that a total of 3 chip failures may be corrected when 4 parity dice are available.

As shown by reference number 804, a 20-die stripe may include 14 dice for storing a data block and 6 parity dice for error correction. The 14 dice may be associated with 112 bytes of data (e.g., each die may be 8 bytes). The 6 parity dice may be associated with a real triple device data correction. By reconfiguring an ECC stripe and storing corrected data on certain parity dice, a sequential five device data correction may be achieved. The 6 parity dice may be utilized to correct 3 chip failures. Corrected data may be stored on 3 of the 6 parity dice, 1 parity die may be used as a spare resource for a next chip failure, and the remaining 2 parity dice may be used to implement a single device data correction. The single device data correction may be able to correct 1 additional chip failure, such that a total of 5 chip failures may be corrected when 6 parity dice are available.

As shown by reference number 806, a 20-die stripe may include 12 dice for storing a data block and 8 parity dice for error correction. The 12 dice may be associated with 96 bytes of data (e.g., each die may be 8 bytes). The 8 parity dice may be associated with a real quad device data correction. By reconfiguring an ECC stripe and storing corrected data on certain parity dice, a sequential seven device data correction may be achieved. The 8 parity dice may be utilized to correct 4 chip failures. Corrected data may be stored on 4 of the 8 parity dice, and the remaining 4 parity dice may be used to implement a double device data correction. The double device data correction may be able to correct 3 additional chip failures (e.g., by correcting 2 chip failures and then employing a single device data correction to correct one additional chip failure), such that a total of 7 chip failures may be corrected when 8 parity dice are available.

As indicated above, FIG. 8 is provided as an example. Other examples may differ from what is described with regard to FIG. 8.

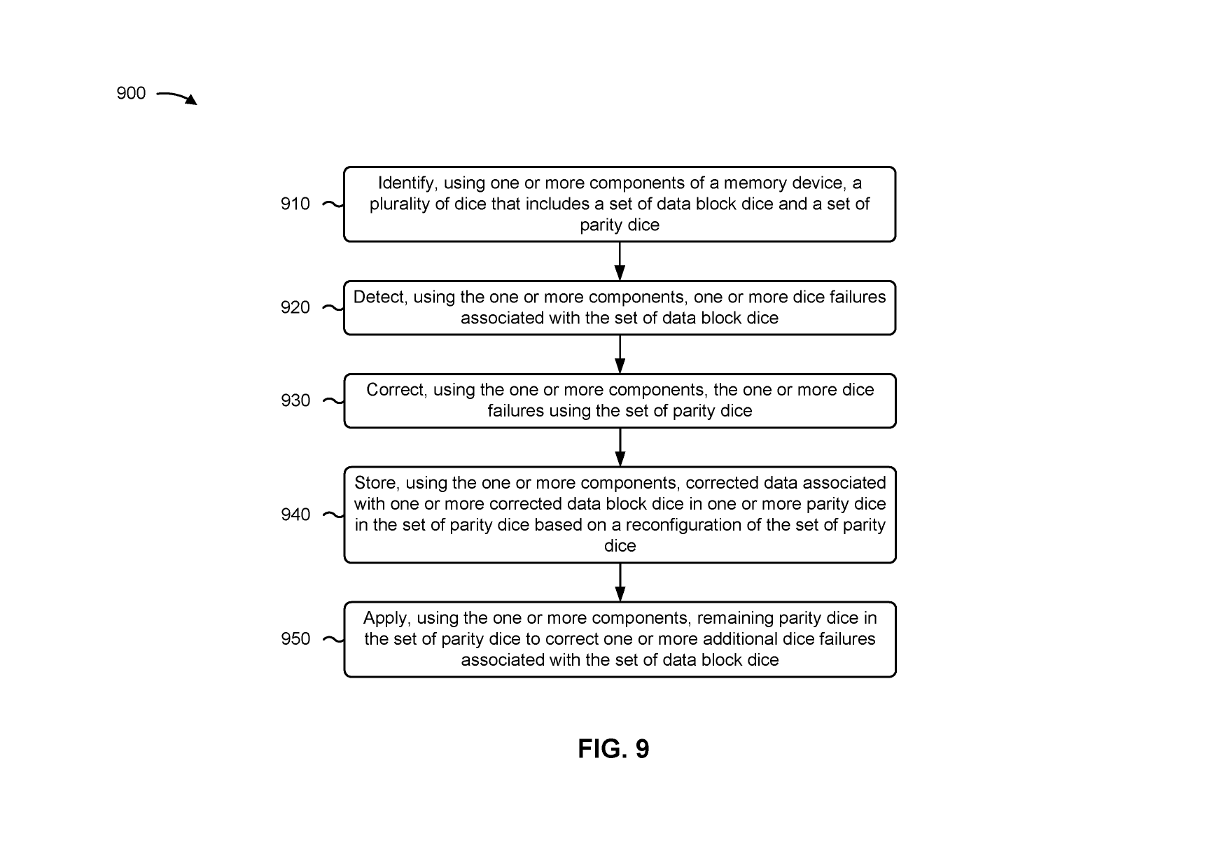

FIG. 9 is a flowchart of an example method 900 associated with dice failure correction using parity dice. In some implementations, a memory device (e.g., the memory device 120) may perform or may be configured to perform the method 900. In some implementations, another device or a group of devices separate from or including the memory device (e.g., the system 100) may perform or may be configured to perform the method 900. Additionally, or alternatively, one or more components of the memory device may perform or may be configured to perform the method 900. Thus, means for performing the method 900 may include the memory device and/or one or more components of the memory device. Additionally, or alternatively, a non-transitory computer-readable medium may store one or more instructions that, when executed by the memory device, cause the memory device to perform the method 900.

As shown in FIG. 9, the method 900 may include identifying, using one or more components of a memory device, a plurality of dice that includes a set of data block dice and a set of parity dice (block 910). As further shown in FIG. 9, the method 900 may include detecting, using the one or more components, one or more dice failures associated with the set of data block dice (block 920). As further shown in FIG. 9, the method 900 may include correcting, using the one or more components, the one or more dice failures using the set of parity dice (block 930). As further shown in FIG. 9, the method 900 may include storing, using the one or more components, corrected data associated with one or more corrected data block dice in one or more parity dice in the set of parity dice based on a reconfiguration of the set of parity dice (block 940). As further shown in FIG. 9, the method 900 may include applying, using the one or more components, remaining parity dice in the set of parity dice to correct one or more additional dice failures associated with the set of data block dice (block 950).

The method 900 may include additional aspects, such as any single aspect or any combination of aspects described below and/or described in connection with one or more other methods or operations described elsewhere herein.

In a first aspect, the remaining parity dice do not store the corrected data associated with the one or more corrected data block dice.

In a second aspect, alone or in combination with the first aspect, the set of data block dice is associated with a first quantity, wherein the set of parity dice is associated with a second quantity, and a quantity of dice failures that are able to be corrected using parity dice is based on one or more of the first quantity or the second quantity.

In a third aspect, alone or in combination with one or more of the first and second aspects, the set of parity dice are used for a baseline dice failure correction, and the remaining parity dice are used for a residual dice failure correction.

In a fourth aspect, alone or in combination with one or more of the first through third aspects, the plurality of dice corresponds to a stripe of N dice, where N is a positive integer.

In a fifth aspect, alone or in combination with one or more of the first through fourth aspects, the remaining parity dice are used for single device data correction or double device data correction.

In a sixth aspect, alone or in combination with one or more of the first through fifth aspects, the plurality of dice corresponds to a plurality of memory chips or a plurality of memory components.

In a seventh aspect, alone or in combination with one or more of the first through sixth aspects, the memory device is a DDR memory device.

In an eighth aspect, alone or in combination with one or more of the first through seventh aspects, the memory device is a volatile memory device.

Although FIG. 9 shows example blocks of a method 900, in some implementations, the method 900 may include additional blocks, fewer blocks, different blocks, or differently arranged blocks than those depicted in FIG. 9. Additionally, or alternatively, two or more of the blocks of the method 900 may be performed in parallel. The method 900 is an example of one method that may be performed by one or more devices described herein. These one or more devices may perform or may be configured to perform one or more other methods based on operations described herein.

In some implementations, a memory device includes one or more components configured to: identify a plurality of dice that includes a set of data block dice and a set of parity dice; detect one or more dice failures associated with the set of data block dice; correct the one or more dice failures using the set of parity dice; store corrected data associated with one or more corrected data block dice in one or more parity dice in the set of parity dice based on a reconfiguration of the set of parity dice; and apply remaining parity dice in the set of parity dice to correct one or more additional dice failures associated with the set of data block dice.

In some implementations, a method includes identifying, using one or more components of a memory device, a plurality of dice that includes a set of data block dice and a set of parity dice; detecting, using the one or more components, one or more dice failures associated with the set of data block dice; correcting, using the one or more components, the one or more dice failures using the set of parity dice; storing, using the one or more components, corrected data associated with one or more corrected data block dice in one or more parity dice in the set of parity dice based on a reconfiguration of the set of parity dice; and applying, using the one or more components, remaining parity dice in the set of parity dice to correct one or more additional dice failures associated with the set of data block dice.

In some implementations, an apparatus includes means for identifying a plurality of dice that includes a set of data block dice and a set of parity dice; means for detecting one or more dice failures associated with the set of data block dice; means for correcting the one or more dice failures using the set of parity dice; means for storing corrected data associated with one or more corrected data block dice in one or more parity dice in the set of parity dice based on a reconfiguration of the set of parity dice; and means for applying remaining parity dice in the set of parity dice to correct one or more additional dice failures associated with the set of data block dice.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
identify a plurality of dice that includes a set of data block dice and a set of parity dice;
detect one or more dice failures associated with the set of data block dice;
correct the one or more dice failures using the set of parity dice;
store corrected data associated with one or more corrected data block dice in one or more parity dice in the set of parity dice based on a reconfiguration of the set of parity dice; and
apply remaining parity dice in the set of parity dice to correct one or more additional dice failures associated with the set of data block dice.

2. The memory device of claim 1, wherein the remaining parity dice do not store the corrected data associated with the one or more corrected data block dice.

3. The memory device of claim 1, wherein the set of data block dice is associated with a first quantity, wherein the set of parity dice is associated with a second quantity, and wherein a quantity of dice failures that are able to be corrected using parity dice is based on one or more of the first quantity or the second quantity.

4. The memory device of claim 1, wherein the set of parity dice are used for a baseline dice failure correction, and wherein the remaining parity dice are used for a residual dice failure correction.

5. The memory device of claim 1, wherein the plurality of dice corresponds to a stripe of N dice, where N is a positive integer.

6. The memory device of claim 1, wherein the remaining parity dice are used for single device data correction or double device data correction.

7. The memory device of claim 1, wherein the plurality of dice corresponds to a plurality of memory chips or a plurality of memory components.

8. The memory device of claim 1, wherein the memory device is a double data rate (DDR) memory device.

9. The memory device of claim 1, wherein the memory device is a volatile memory device.

10. A method, comprising:
identifying, using one or more components of a memory device, a plurality of dice that includes a set of data block dice and a set of parity dice;
detecting, using the one or more components, one or more dice failures associated with the set of data block dice;
correcting, using the one or more components, the one or more dice failures using the set of parity dice;
storing, using the one or more components, corrected data associated with one or more corrected data block dice in one or more parity dice in the set of parity dice based on a reconfiguration of the set of parity dice; and
applying, using the one or more components, remaining parity dice in the set of parity dice to correct one or more additional dice failures associated with the set of data block dice.

11. The method of claim 10, wherein the remaining parity dice do not store the corrected data associated with the one or more corrected data block dice.

12. The method of claim 10, wherein the set of data block dice is associated with a first quantity, wherein the set of parity dice is associated with a second quantity, and wherein a quantity of dice failures that are able to be corrected using parity dice is based on one or more of the first quantity or the second quantity.

13. The method of claim 10, wherein the set of parity dice are used for a baseline dice failure correction, and wherein the remaining parity dice are used for a residual dice failure correction.

14. The method of claim 10, wherein the plurality of dice corresponds to a stripe of N dice, where N is a positive integer.

15. The method of claim 10, wherein the remaining parity dice are used for single device data correction or double device data correction.

16. The method of claim 10, wherein the plurality of dice corresponds to a plurality of memory chips or a plurality of memory components.

17. The method of claim 10, wherein the memory device is a double data rate (DDR) memory device.

18. The method of claim 10, wherein the memory device is a volatile memory device.

19. An apparatus, comprising:
means for identifying a plurality of dice that includes a set of data block dice and a set of parity dice;
means for detecting one or more dice failures associated with the set of data block dice;
means for correcting the one or more dice failures using the set of parity dice;
means for storing corrected data associated with one or more corrected data block dice in one or more parity dice in the set of parity dice based on a reconfiguration of the set of parity dice; and
means for applying remaining parity dice in the set of parity dice to correct one or more additional dice failures associated with the set of data block dice.

20. The apparatus of claim 19, wherein the remaining parity dice do not store the corrected data associated with the one or more corrected data block dice.

21. The apparatus of claim 19, wherein the set of data block dice is associated with a first quantity, wherein the set of parity dice is associated with a second quantity, and wherein a quantity of dice failures that are able to be corrected using parity dice is based on one or more of the first quantity or the second quantity.

22. The apparatus of claim 19, wherein the set of parity dice are used for a baseline dice failure correction, wherein the remaining parity dice are used for a residual dice failure correction, and wherein the remaining parity dice are used for single device data correction or double device data correction.

23. The apparatus of claim 19, wherein the plurality of dice corresponds to a stripe of N dice, where N is a positive integer, and wherein the plurality of dice corresponds to a plurality of memory chips or a plurality of memory components.

24. The apparatus of claim 19, wherein the apparatus is a double data rate (DDR) memory device.

25. The apparatus of claim 19, wherein the apparatus is a volatile memory device.
